(19) United States
(12) Patent Application Publication
(10) Pub. No.: US 2015/0274525 A1
(43) Pub. Date: Oct. 1, 2015

(54) OZONE GENERATOR

(71) Applicant: NGK INSULATORS, LTD., Nagoya-city (JP)

(72) Inventors: Yoshimasa KONDO, Nagoya-City (JP); Shoji YOKOI, Nagoya-City (JP); Tatsuya TERAZAWA, Kasugai-City (JP); Naoya TAKASE, Konan-City (JP)

(21) Appl. No.: 14/666,748

(22) Filed: Mar. 24, 2015

(30) Foreign Application Priority Data
Mar. 28, 2014 (JP) 2014-069903

(51) Int. Cl. C01B 13/11

(52) U.S. Cl. CPC C01B 13/115

(57) ABSTRACT

An ozone generator includes one or more electrode pairs, wherein the electrode pairs each contain two electrodes arranged at a distance of a predetermined gap length, and ozone is produced when a source gas flows at least between the two electrodes of the electrode pair and a discharge is generated between the two electrodes. One of the two electrodes is located on an upstream side of the source gas and another is located on a downstream side of the source gas. A direction from the one electrode toward the other electrode is inclined with respect to a supply direction of the source gas.

### CROSS-REFERENCE TO RELATED APPLICATION

This application is based upon and claims the benefit of priority from Japanese Patent Application No. 2014-069903 filed on Mar. 28, 2014, the contents of which are incorporated herein by reference.

### BACKGROUND OF THE INVENTION

1. Field of the Invention

The present invention relates to an ozone generator for flowing a source gas between electrodes and generating a discharge between the electrodes, thereby producing ozone.

2. Description of the Related Art

An ozone generator is an apparatus capable of flowing an oxygen-containing gas such as air in a thermal non-equilibrium plasma to produce ozone. The thermal non-equilibrium plasma is generated utilizing a discharge provided by a discharge generating device. For example, the discharge generating device may be of a silent discharge type. For example, in this device, a high voltage of several to several tens kV is applied by a high-voltage alternating-current power source to a discharge gap between a high-voltage electrode and a ground electrode, to generate a discharge of an aggregate of micro-discharge columns. The oxygen-containing gas is decomposed by the discharge to produce ozone.

Conventional structures of such an ozone generator are disclosed, e.g., in Japanese Laid-Open Patent Publication Nos. 10-324504 and 2013-060327.

Japanese Laid-Open Patent Publication No. 10-324504 describes in paragraph [0002] that a silent discharge-type ozone generator has electrodes facing each other and one or two dielectric bodies interposed therebetween, a high alternating-current voltage is applied to the electrodes while flowing an oxygen-containing source gas (such as a high-concentration oxygen (PSA oxygen) gas or a dehumidified air) in a gap between the electrode and the dielectric body or in a gap between the dielectric bodies, and oxygen is dissociated by a silent discharge to produce ozone. The gap has a length of about 1 mm, and the dielectric body is made of a glass or ceramic material having a high dielectric strength.

Japanese Laid-Open Patent Publication No. 2013-060327 describes in paragraph [0008] that an ozone generator contains a discharge electrode, an induction electrode facing the discharge electrode, a dielectric body layer formed between the discharge electrode and the induction electrode, and a water-repellent layer formed on the discharge electrode.

### SUMMARY OF THE INVENTION

However, the conventional ozone generators are disadvantageous in that the produced ozone is decomposed by a water molecule or an OH group (hydroxyl group), resulting in a lowered ozone production efficiency, in a high-humidity environment.

In Japanese Laid-Open Patent Publication No, 10-324504, the source gas flows between the two electrodes (an electrode pair) with the dielectric body interposed therebetween. As shown in FIGS. 4 and 5 of Japanese Laid-Open Patent Publication. No. 10-324504, the electrode pair direction (the direction from one electrode to the other electrode) is perpendicular to (at an angle of 90°) the source gas flow direction. Therefore, the discharge surfaces of the electrodes are brought into direct contact with the humidified source gas, whereby the ozone production may be inhibited by the water or OH molecules, so that the ozone production efficiency may be reduced or the ozone production may be stopped.

In Japanese Laid-Open Patent Publication No. 2013-060327, the water-repellent layer is formed on the discharge electrode. However, as described in paragraph [0020] of Japanese Laid-Open Patent Publication No. 2013-060327, the water-repellent layer may be peeled off during a long operation even when a protective film for preventing the peeling is formed between the dielectric body layer and the water-repellent layer. Furthermore, the ozone production efficiency is lowered with the operation time in a high-humidity environment disadvantageously.

In view of the above problems, an object of the present invention is to provide an ozone generator capable of reducing the changes in the ozone production even in a usage environment at high humidity, and stably producing ozone in a wide range of humidity environments (with an absolute humidity of 0 to 50 g/m³).

[1] An ozone generator according to the present invention includes one or more electrode pairs, wherein the electrode pairs each contain two electrodes arranged at a distance of a predetermined gap length, and ozone is produced when a source gas flows at least between the two electrodes of the electrode pair and a discharge is generated between the two electrodes. One of the two electrodes is located on an upstream side of the source gas and another is located on a downstream side of the source gas. A direction from the one electrode toward the other electrode is inclined with respect to a supply direction of the source gas.

In this case, one side of the discharge surfaces of the electrode pairs is not brought into direct contact with the source gas, whereby the one side of the discharge surfaces is not brought into direct contact with water or OH molecules and can be maintained in a low-humidity state. Thus, the reduction of the ozone production amount can be decreased.

[2] In the present invention, it is preferred that an angle between the direction from the one electrode toward the other electrode (hereinafter referred to as an electrode pair direction) and the supply direction of the source gas has an absolute value of 80° or less. In this case, one side of the discharge surfaces of the electrode pairs is not brought into direct contact with the source gas. Therefore, the one side of the discharge surfaces is not brought into direct contact with the water or OH molecules and can be maintained in a low-humidity state. Thus, the reduction of the ozone production amount can be decreased.

[3] In the present invention, it is preferred that an angle between the direction from the one electrode toward the other electrode and the supply direction of the source gas has an absolute value of 60° or less. In this case, the reduction of the source gas amount can be decreased between the two electrodes, one side of the electrode pair can be maintained in a low-humidity state, and the ozone production amount can be increased.

[4] In the present invention, it is preferred that an angle between the direction from the one electrode toward the other electrode and the supply direction of the source gas has an absolute value of 10° or more. In this case, the reduction of the ozone production amount, due to lack of the source gas between the one electrode and the other electrode (in the discharge space), can be decreased.

[5] In the present invention, it is preferred that an angle between the direction from the one electrode toward the other electrode and the supply direction of the source gas has an absolute value of 30° or more. In this case, the reduction of the source gas amount can be decreased between the two electrodes, one side of the electrode pair can be maintained in a low-humidity state, and the ozone production amount can be increased.

[6] In the present invention, the source gas may be an atmospheric air having an absolute humidity of 0 to 50 g/m³.

[7] In the present invention, it is preferred that the gap length is at least 0.1 mm and less than 100 mm. In this case, the ozone generator can reduce the changes in the ozone production even in a usage environment at high humidity, and can stably act to produce ozone in a wide range of humidity environments (with an absolute humidity of 0 to 50 g/m³).

[8] In the present invention, each of the electrodes may contain a tubular dielectric body having a hollow portion and a conductive body disposed in the hollow portion of the dielectric body.

[9] In the present invention, a discharge space may be formed between the two electrodes, the electrode pairs may be arranged in parallel, in series, or in parallel and series, and the ozone generator may have a non-discharge portion on a source gas passage plane having a normal direction parallel to a main flow direction of the source gas.

The ozone generator of the present invention can reduce the changes in the ozone production even in a usage environment at high humidity and can stably act to produce ozone in a wide range of humidity environments (with an absolute humidity of 0 to 50 g/m³).

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a longitudinal cross-sectional view of a principal part of an ozone generator according to an embodiment of the present invention;

FIG. 2 is a cross-sectional view taken along the line II-II of FIG. 1;

FIG. 3 is an explanatory view for illustrating an operation of the ozone generator according to the embodiment;

FIG. 4 is a longitudinal cross-sectional view of the principal part of the ozone generator according to another example of the embodiment;

FIG. 5 is a longitudinal cross-sectional view of a principal part of an ozone generator according to a first modification example;

FIG. 6 is a longitudinal cross-sectional view of a principal part of an ozone generator according to a second modification example;

FIG. 7 is a longitudinal cross-sectional view of a principal part of an ozone generator according to a third modification example; and

FIG. 8 is a graph showing the changes in the ozone production amount under various supply flow rates of a source gas in samples 1 to 7.

### DESCRIPTION OF THE PREFERRED EMBODIMENTS

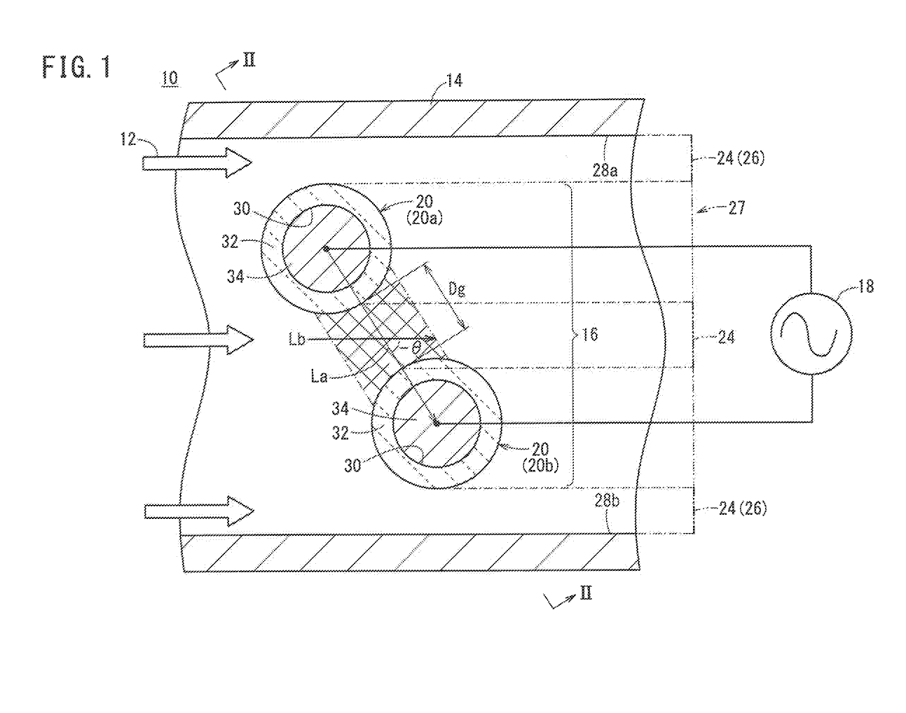

An embodiment of the ozone generator of the present invention will be described below with reference to FIGS. 1 to 8. In this description, a numeric range of “A to B” includes both the numeric values A and B as the lower limit and upper limit values.

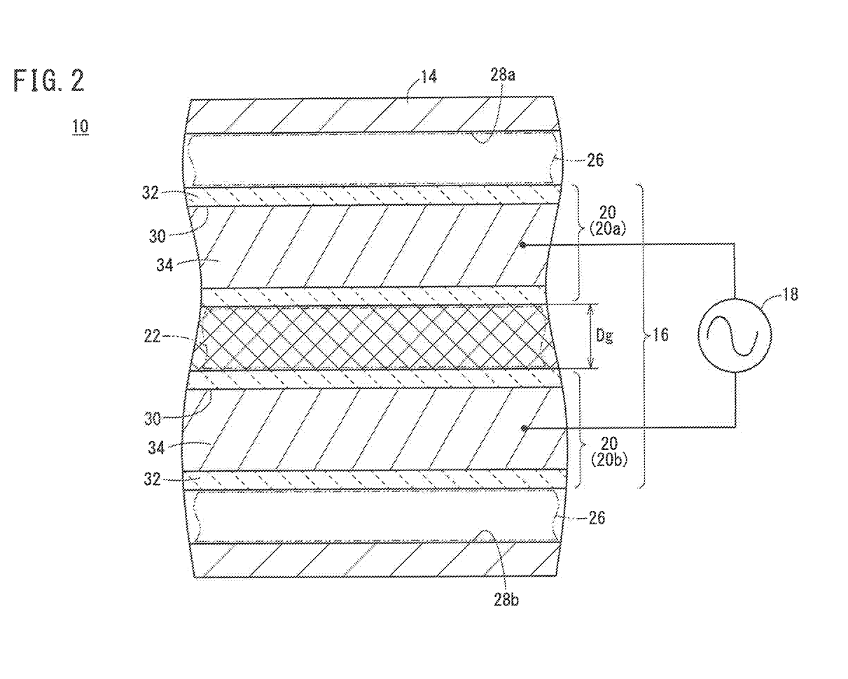

As shown in FIGS. 1 and 2, an ozone generator 10 according to this embodiment includes a housing 14 through which a source gas 12 flows, one or more electrode pairs 16 disposed in the housing 14, and an alternating-current power source 18. Each of the electrode pairs 16 contains two electrodes 20 (a first electrode 20a and a second electrode 20b) arranged at a distance of a predetermined gap length Dg. The alternating-current power source 18 applies an alternating-current voltage v between the two electrodes 20.

In the ozone generator 10, ozone is produced when the source gas 12 flows at least between the two electrodes 20 in the electrode pairs 16 and a discharge is generated between the two electrodes 20. A space formed between the two electrodes 20, in which the discharge is generated, is defined as the discharge space 22.

In the ozone generator 10, non-discharge portions 26 are formed on a source gas passage plane 24 having a normal direction parallel to the main flow direction of the source gas 12. For example, as shown in FIG. 1, the source gas passage planes 24 are shown by thick two-dot chain lines, in a plane 27 (shown by a two-dot chain line) having a normal direction parallel to the main flow direction of the source gas 12. In the source gas passage planes 24, the non-discharge portions 26 are provided by a portion between the first electrode 20a and one inner wall 28a of the housing 14 (an inner wall closer to the first electrode 20a), and a portion between the second electrode 20b and another inner wall 28b of the housing 14 (an inner wall closer to the second electrode 20b). The main flow direction of the source gas 12 is the flow direction which is oriented at the center of the source gas 12. Thus, the main flow direction is different from flow directions of non-oriented peripheral flow components of the source gas 12.

Each of the electrodes 20 has a rod shape, and contains a tubular dielectric body 32 having a hollow portion 30, and further contains a conductive body 34 disposed in the hollow portion 30 of the dielectric body 32. In the example of FIGS. 1 and 2, the dielectric body 32 has a cylindrical shape, and the hollow portion 30 formed therein has a circular sectional shape. The conductive body 34 has a circular sectional shape. Of course, the shapes of the components are not limited to the example. The dielectric body 32 may have a tubular shape with a polygonal section such as a triangular, quadrangular, pentangular, hexangular, or octangular section. The conductive body 34 may have a columnar shape with a polygonal section such as a triangular, quadrangular, pentangular, hexangular, or octangular section corresponding to the shape of the dielectric body 32.

In this embodiment, the source gas 12 is used for the purpose of producing ozone, and therefore may be an atmospheric air, an oxygen-containing gas, etc. In this case, the source gas 12 may be a non-dehumidified air.

The material of the conductive body 34 preferably contains a substance selected from the group consisting of molybdenum, tungsten, silver, copper, nickel, and alloys containing at least one thereof. Examples of such alloys include invar, kovar, inconel (registered trademark), and incoloy (registered trademark).

The material of the dielectric body 32 is preferably a ceramic material that can be fired at a temperature lower than the melting point of the conductive body 34. For example, the material is preferably a single-oxide, composite-oxide, or composite-nitride material containing one or more substances selected from the group consisting of barium oxide, bismuth oxide, titanium oxide, zinc oxide, neodymium oxide, titanium nitride, aluminum nitride, silicon nitride, alumina, silica, and mullite.

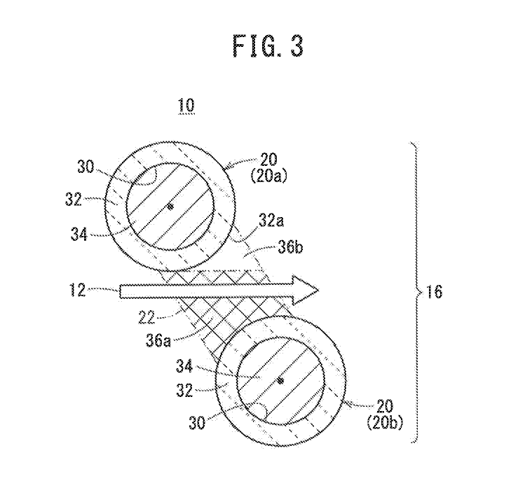

In this embodiment, as shown in FIGS. 1 and 3, the first electrode 20a is located on the upstream side of the source gas 12 and the second electrode 20b is located on the downstream side of the source gas 12, of the two electrodes in an electrode pair. Furthermore, a direction La from the upstream first electrode 20a toward the downstream second electrode 20b is inclined with respect to a supply direction Lb of the source gas 12.

Therefore, as shown in FIG. 3, a region 36a in which the source gas 12 flows and a region 36b in which the source gas 12 hardly flows are formed in the discharge space 22 between the first electrode 20a and the second electrode 20b. Thus, on the surface of the dielectric body 32 in the first electrode 20a, a surface in the discharge space 22 (a discharge surface 32a) is not brought into direct contact with the source gas 12. Consequently, the discharge surface 32a of the dielectric body 32 in the first electrode 20a is not brought into direct contact with the water or OH molecules and thereby can be maintained in the low-humidity state, so that the reduction of the ozone production amount can be decreased.

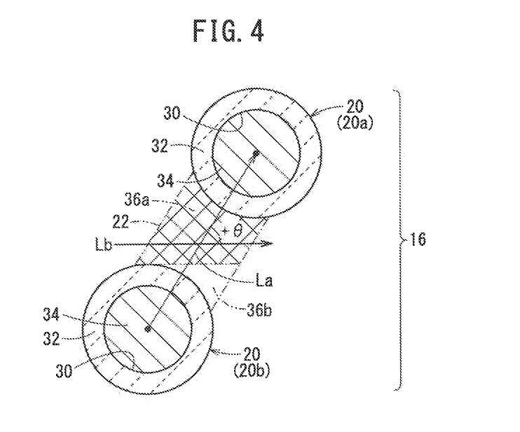

Of course, as shown in FIG. 4, of the two electrodes 20 in each electrode pair 16, the second electrode 20b may be located on the upstream side of the source gas 12, and the first electrode 20a may be located on the downstream side of the source gas 12. Also in this case, the direction La from the upstream second electrode 20b toward the downstream first electrode 20a is inclined with respect to the supply direction Lb of the source gas 12.

Accordingly, the discharge surface 32a of the dielectric body 32 in the second electrode 20b is not brought into direct contact with the source gas 12. Consequently, the discharge surface 32a of the dielectric body 32 in the second electrode 20b is not brought into direct contact with the water or OH molecules and thereby can be maintained in the low-humidity state, so that the reduction of the ozone production amount can be decreased.

Specifically, as shown in FIGS. 1 and 4, it is preferred that the angle (±0) between the direction from the upstream electrode (the first electrode 20a or the second electrode 20b) toward the downstream electrode (the second electrode 20b or the first electrode 20a) (hereinafter referred to as the electrode pair direction La) and the supply direction Lb of the source gas 12 has an absolute value of 80° or less. The angle is −θ in FIG. 1 and is +θ in FIG. 4. In this case, the reduction of the ozone production amount, due to lack of the source gas 12 in the discharge space 22 between the first electrode 20a and the second electrode 20b, can be decreased.

It is preferred that the angle (±0) between the direction La of the electrode pair 16 and the supply direction Lb of the source gas 12 has an absolute value of 10° or more. In this case, one of the discharge surfaces 32a in each electrode pairs 16 is not brought into direct contact with the source gas 12. Consequently, one of the discharge surfaces 32a is not brought into direct contact with the water or OH molecules and thereby can be maintained in the low-humidity state, so that the reduction of the ozone production amount can be decreased.

It is preferred that the angle (±θ) between the direction La of the electrode pair 16 and the supply direction Lb of the source gas 12 has an absolute value of 60° or less. It is preferred that the angle (±θ) between the direction La of the electrode pair 16 and the supply direction Lb of the source gas 12 has an absolute value of 30° or more. In this case, the reduction of the supply amount of the source gas 12 can be decreased between the two electrodes 20, one of the electrodes 20 in the electrode pair 16 can be maintained in the low-humidity state, and a large ozone production amount can be achieved.

Thus, in this embodiment, even when the supplied source gas 12 has a high humidity, the reduction of the ozone production amount due to the ozone decomposition reactions can be decreased, and the residual amount of the unreacted source gas 12 flowing through the discharge spaces 22, can be reduced. Consequently, the ozone generator 10 can exhibit a high ozone production efficiency.

As a result, the ozone generator can reduce the changes in the ozone production even at high humidity and can stably act to produce ozone in a wide range of humidity environments (with an absolute humidity of 0 to 50 g/m³).

In addition, the water-repellent layer such as the one described in Japanese Laid-Open Patent Publication No. 2013-060327 is not used in the invention. Therefore, the ozone generator can exhibit a stable ozone production amount over a long period without peeling of the water-repellent layer during a long operation.

Several preferred modifications of the ozone generator 10 according to this embodiment will be described below.

The gap length Dg between the two electrodes 20 means the shortest distance between the dielectric body 32 in the first electrode 20a and the dielectric body 32 in the second electrode 20b. The gap length Dg is preferably at least 0.1 mm and less than 1.0 mm.

When the gap length Dg is excessively large, the distance between the dielectric bodies 32 is excessively increased, whereby the amount of the water or OH molecules is increased in the central portion of the discharge space 22. Therefore, in the high-humidity environment, the ozone production is inhibited, the ozone production efficiency is reduced, or the ozone production is stopped, by the water or OH molecules which are contained in the source gas 12 and remain around the dielectric bodies 32 or in the central portion of the discharge space 22.

When the gap length Dg is excessively small, the discharge space 22 may be short-circuited by the water or OH molecules adsorbed to the dielectric bodies 32. Thus, the dielectric bodies 32 may be connected by the water or OH molecules. In this case, the ozone production is inhibited, the ozone production efficiency is reduced, or the ozone production is stopped, by the water or OH molecules, as in the case where a large amount of the water or OH molecules remain in the central portion of the discharge space 22.

Consequently, the gap length Dg is preferably at least 0.1 mm and less than 1.0 mm.

In this embodiment, each electrode 20 contains the tubular dielectric body 32 having the hollow portion 30 and the conductive body 34 disposed in the hollow portion 30 of the dielectric body 32. Therefore, the distance between the electrodes 20 can be easily controlled. Thus, the gap length Dg between the electrodes 20 can be more easily controlled within the range of at least 0.1 mm and less than 1.0 mm as compared with the creeping discharge-type structure described in Japanese Laid-Open Patent Publication No. 10-324504.

The electrode 20 may be produced by the following method. Thus, for example, a tubular compact or green body is preliminarily fired to prepare a preliminarily fired body having a hollow portion, and the conductive body 34 is inserted into the hollow portion of the preliminarily fired body. Then, the preliminarily fired body and the conductive body 34 are fired to be directly integrated with each other at a temperature higher than the preliminary firing temperature, whereby the electrode 20 containing the dielectric body 32 having the hollow portion 30 and the conductive body 34 inserted into the hollow portion 30 is produced.

Alternatively, the electrode 20 may be produced by a gel casting method. In the gel casting method, the conductive body 34 is placed in a mold, a slurry containing a ceramic powder, a dispersion medium, and a gelling agent is cast into the mold, the slurry is gelled, solidified, and molded by changing the temperature or by adding a cross-linker, and the resultant is fired to produce the electrode 20.

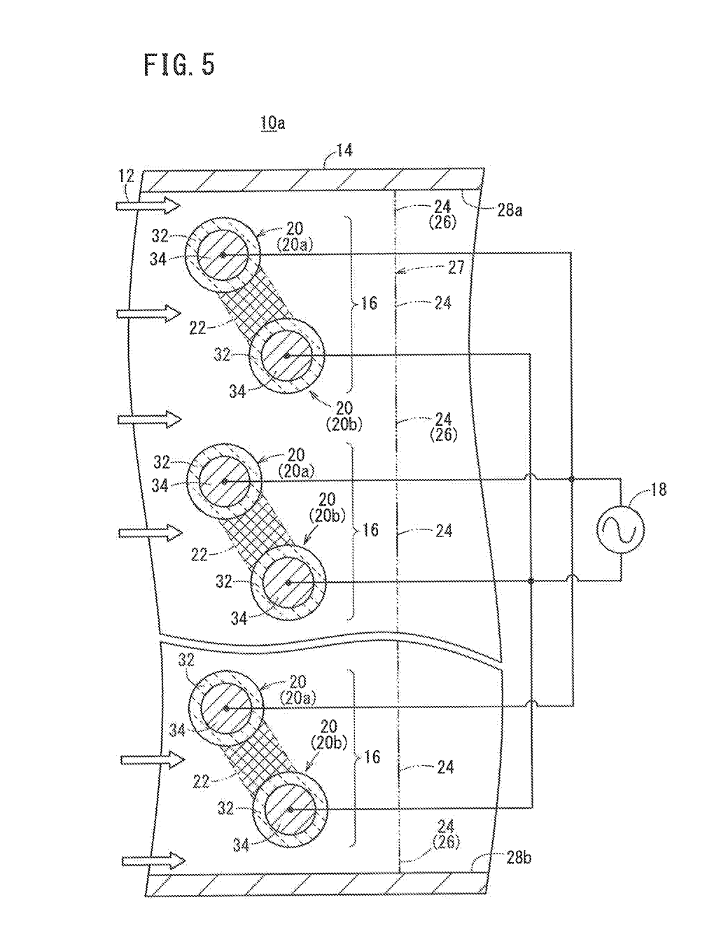

In the above embodiment, one electrode pair 16 is shown. Alternatively, first to third modification examples shown in FIGS. 5 to 7 will also be adopted preferably.

As shown in FIG. 5, an ozone generator 10a according to the first modification example is different from the ozone generator 10 (see FIG. 1) in that a plurality of the electrode pairs 16 are arranged in parallel. The alternating-current power source 18 applies an alternating-current voltage v between the first electrodes 20a and the second electrodes 20b.

In the ozone generator 10a, the non-discharge portions 26 are also formed on the source gas passage plane 24. Specifically, in the source gas passage plane 24, the non-discharge portions 26 are provided by portions between the electrode pairs 16, a portion between the one inner wall 28a of the housing 14 and the first electrode 20a which is closer to the one inner wall 28a, and a portion between the other inner wall 28b of the housing 14 and the second electrode 20b which is closer to the other inner wall 28b. Though all the electrode pairs 16 extend in the same direction La and at the same angle in the first modification example, some of the electrode pairs 16 may extend in a different direction or at a different angle.

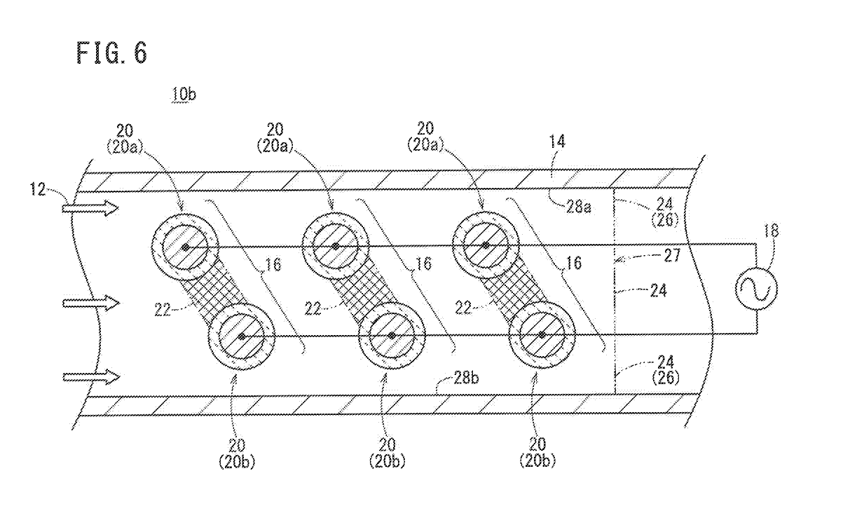

As shown in FIG. 6, an ozone generator 10b according to the second modification example is different from the ozone generator 10 (see FIG. 1) in that a plurality of the electrode pairs 16 are arranged in series. The alternating current power source 18 applies an alternating-current voltage v between the first electrodes 20a and the second electrodes 20b.

In the ozone generator 10b, the non-discharge portions 26 are also formed on the source gas passage plane 24. Specifically, the non-discharge portions 26 are provided by portions between the one inner wall 28a of the housing 14 and the first electrodes 20a of the plural electrode pairs 16, and portions between the other inner wall 28b of the housing 14 and the second electrodes 20b of the plural electrode pairs 16.

Though all the electrode pairs 16 extend in the same direction La and at the same angle in the second modification example, some of the electrode pairs 16 may extend in a different direction or at a different angle.

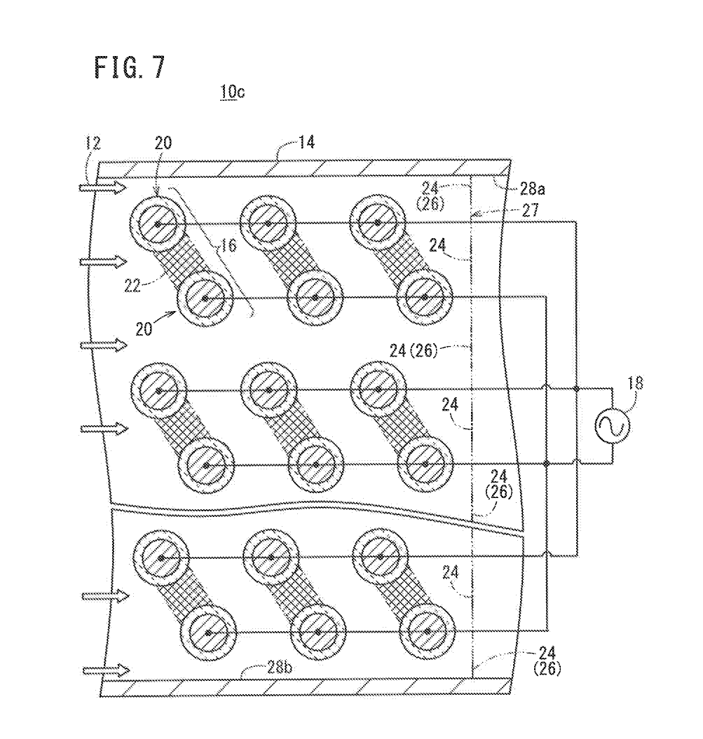

As shown in FIG. 7, an ozone generator 10c according to the third modification example is different from the ozone generator 10 (see FIG. 1) in that a plurality of the electrode pairs 16 are arranged in parallel and series. The alternating-current power source 18 applies an alternating-current voltage v between the first electrodes 20a and the second electrodes 20b.

In the ozone generator 10c, the non-discharge portions 26 are also formed on the source gas passage plane 24. Though all the electrode pairs 16 extend in the same direction La and at the same angle in the third modification example, some of the electrode pairs 16 may extend in a different direction or at a different angle.

In the ozone generator 10 of this embodiment, the flow volume of the source gas 12 is preferably 380 L/min or less in one discharge space 22. The flow volume is more preferably 300 L/min or less, further preferably 150 L/min or less.

In this case, the distribution of the source gas 12 in the discharge space 22 can be reduced, the ozone molecules can be uniformly produced in the discharge space 22, and the source gas 12 can be used up for the ozone production, so that insufficient production of the ozone molecules due to too much source gas 12 can be avoided. Therefore, the reduction of the ozone production amount due to the ozone decomposition can be decreased, and the residual amount of the unreacted source gas 12 flowing through the discharge space 22 can be reduced. Consequently, the ozone generator 10 can exhibit a high ozone production efficiency.

Changes in ozone production amount in samples 1 to 7 were evaluated under various supply flow rates of a source gas. In the samples 1 to 7, the dielectric body 32 was made of alumina and the conductive body 34 was made of copper in each electrode 20.

### (Method for Measuring Ozone Production Amount)

In the measurement of the ozone production amount, an air (having an absolute humidity of 30 g/m³) was used as the source gas 12 under a gas pressure of 0.10 MPa.

The alternating-current power source 18 was used as a discharge power source for applying an alternating-current voltage v with a voltage (amplitude A) of ±4 kV and a frequency f of 20 kHz.

The ozone concentration in the exhaust gas was measured using an ozone concentration meter ES-3000D (available from Ebara Jitsugyo Co., Ltd.) under the above conditions. The ozone production amount was obtained by multiplying the measured value by a supply flow rate.

The details of electrode structures in ozone generators of the samples 1 to 7 were as follows.

### (Sample 1)

The sample 1 had a structure shown in FIGS. 1 and 4, and the angle (±0) between the direction La of the electrode pair 16 and the supply direction Lb of the source gas 12 had a value of ±0°. That is, the direction La of the electrode pair 16 was not inclined with respect to the supply direction Lb of the source gas 12, but in parallel to the supply direction Lb of the source gas 12.

### (Samples 2 to 6)

The structures of the samples 2, 3, 4, 5, and 6 were the same as the structure of the sample 1, except that the angle (±0) between the direction La of the electrode pair 16 and the supply direction Lb of the source gas 12 had values of ±10°, ±30°, ±45°, ±60°, and ±80°, respectively. That is, the direction La of the electrode pair 16 was inclined with respect to the supply direction Lb of the source gas 12.

### (Sample 7)

In the sample 7, the angle (±0) between the direction La of the electrode pair 16 and the supply direction Lb of the source gas 12 had a value of ±90°. That is, the direction La of the electrode pair 16 was not inclined with respect to the supply direction Lb of the source gas 12, but perpendicular to the supply direction Lb of the source gas 12.

### (Evaluation Result)

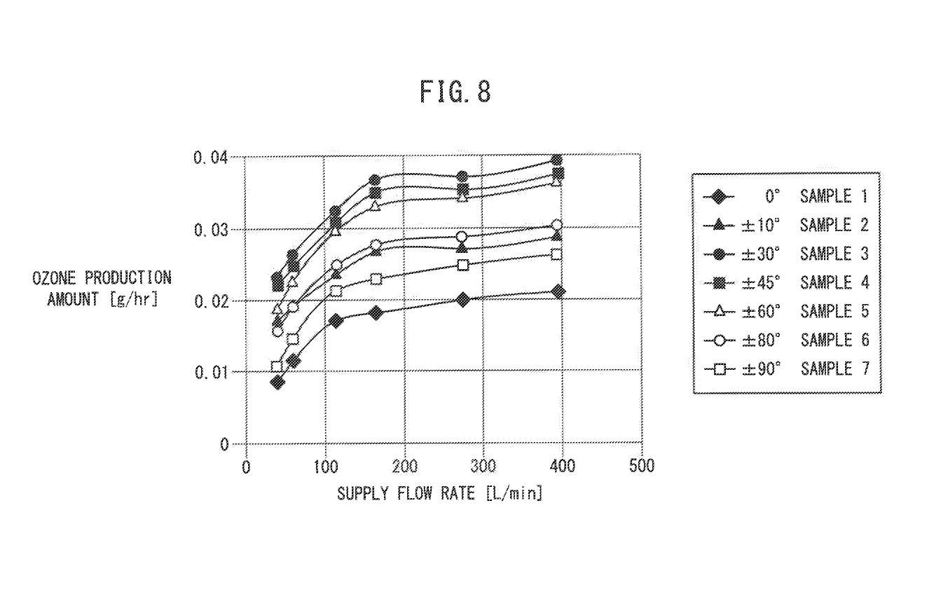

The evaluation results of the samples 1 to 7 are shown in FIG. 8.

As shown in FIG. 8, at every supply flow rate, the amount of the ozone production in the samples 2 to 6, in which the direction La of the electrode pair 16 was inclined with respect to the supply direction Lb of the source gas 12, was larger than those of the samples 1 and 7, in which the direction La of the electrode pair 16 was not inclined with respect to the supply direction Lb of the source gas 12. Particularly, in the samples 3, 4, and 5, in which the angle (±θ) between the direction La of the electrode pair 16 and the supply direction Lb of the source gas 12 had values of ±30°, ±45°, and ±60°, respectively, each amount of the ozone production was larger than the amount of the sample 1 and the amount of the sample 7.

Accordingly, it is preferred that the angle (±θ) between the direction La of the electrode pair 16 and the supply direction Lb of the source gas 12 has an absolute value of 80° or less, more preferably 60° or less. Further, it is preferred that the angle (±θ) between the direction La of the electrode pair 16 and the supply direction Lb of the source gas 12 has an absolute value of 10° or more, more preferably 30° or more.

It is to be understood that the ozone generator of the present invention is not limited to the above embodiments, and various changes and modifications may be made therein without departing from the scope of the invention.

What is claimed is:

1. An ozone generator comprising one or more electrode pairs, wherein the electrode pairs each contain two electrodes arranged at a distance of a predetermined gap length, and ozone is produced when a source gas flows at least between the two electrodes of the electrode pair and a discharge is generated between the two electrodes,
one of the two electrodes is located on an upstream side of the source gas and another is located on a downstream side of the source gas, and
a direction from the one electrode toward the other electrode is inclined with respect to a supply direction of the source gas.

2. The ozone generator according to claim 1, wherein an angle between the direction from the one electrode toward the other electrode and the supply direction of the source gas has an absolute value of 80° or less.

3. The ozone generator according to claim 1, wherein an angle between the direction from the one electrode toward the other electrode and the supply direction of the source gas has an absolute value of 60° or less.

4. The ozone generator according to claim 1, wherein an angle between the direction from the one electrode toward the other electrode and the supply direction of the source gas has an absolute value of 10° or more.

5. The ozone generator according to claim 1, wherein an angle between the direction from the one electrode toward the other electrode and the supply direction of the source gas has an absolute value of 30° or more.

6. The ozone generator according to claim 1, wherein the source gas is an atmospheric air having an absolute humidity of 0 to 50 g/m³.

7. The ozone generator according to claim 1, wherein the gap length is at least 0.1 mm and less than 1.0 mm.

8. The ozone generator according to claim 1, wherein the electrodes each contain a tubular dielectric body having a hollow portion and a conductive body disposed in the hollow portion of the dielectric body.

9. The ozone generator according to claim 1, wherein a discharge space is formed between the two electrodes,
the electrode pairs are arranged in parallel, in series, or in parallel and series, and
the ozone generator has a non-discharge portion on a source gas passage plane having a normal direction parallel to a main flow direction of the source gas.
